(19) United States
(12) Patent Application Publication
(10) Pub. No.: US 2025/0139443 A1
(43) Pub. Date: May 1, 2025

(54) MAPPING INPUT NODES IN A TRANSFORM NETWORK TO INPUT NODES OF A SMALLER TRANSFORM NETWORK

(71) Applicant: INTERNATIONAL BUSINESS MACHINES CORPORATION, ARMONK, NY (US)

(72) Inventors: Aporva Amarnath, White Plains, NY (US); Subhankar Pal, White Plains, NY (US); Yongmo Park, Ann Arbor, MI (US); Alper Buyuktosunoglu, White Plains, NY (US)

(21) Appl. No.: 18/496,443

(22) Filed: Oct. 27, 2023

(51) Int. Cl. G06N 3/088; G06N 3/0455

(52) U.S. Cl. CPC G06N 3/088; G06N 3/0455

(57) ABSTRACT

Provided are a computer program product, system, and method for mapping input nodes in a transform network to input nodes of a smaller transform network. A first transform network having N input nodes and successive columns of interlinked nodes at which input data is processed. A mapping is generated of the N input nodes to n input nodes of a second transform network implemented in processing tiles in a hardware unit, such that n is less than N and multiple of the N input nodes of the first transform network map to one of the n input nodes of the second transform network. The mapping is used to map the N input nodes of the first transform network to n input nodes of the second transform network implemented in hardware.

### BACKGROUND OF THE INVENTION

### 1. Field of the Invention

The present invention relates to a computer program product, system, and method for mapping input nodes in a transform network to input nodes of a smaller transform network.

### 2. Description of the Related Art

Linear transforms, such as Fast Fourier Transform (FFT), Number Theoretic Transform (NTT), discrete cosine transforms (DCT), are used in cryptography, signal processing and other processes. These algorithms are generally encoded as matrix-matrix multiplications, such as in a General Matrix Multiply (GEMM). Butterfly computation has been proposed to improve the operation complexity from O(N²) to O(N log N), such as Cooley-Tukey for the forward pass and Gentleman-Sande for the backward pass. The complexity is reduced by exploiting properties of the values and symmetry in the GEMM matrix.

A butterfly network may be used to implement an FFT, such as an N-point FFT using the Cooley-Tukey (CT) or Gentleman-Sande (GS) techniques. A number theoretic transform (NTT) is a generalization of the FFT obtained by replacing the twiddle factor e\hat{ }(−2πk/N) with an Nth primitive root-of-unity ω₋(N,p) where [symbol] ₋(N,p) [symbol] \hat{ }N=1 “mod” p and p is a prime such that p=kN+1. This effectively means doing a transform over the quotient ring Z/pZ instead of the complex numbers C.

The Singleton/Pease algorithm provides a rearrangement of the computations in the CT/GS butterfly network to create a stage-symmetric compute and communication pattern that is identical for every stage of the network.

### SUMMARY

Provided are a computer program product, system, and method for mapping input nodes in a transform network to input nodes of a smaller transform network. A first transform network having N input nodes and successive columns of interlinked nodes at which input data is processed. A mapping is generated of the N input nodes to n input nodes of a second transform network implemented in processing tiles in a hardware unit, such that n is less than N and multiple of the N input nodes of the first transform network map to one of the n input nodes of the second transform network. The mapping is used to map the N input nodes of the first transform network to n input nodes of the second transform network implemented in hardware.

### BRIEF DESCRIPTION OF THE DRAWINGS

FIG. 1 illustrates an embodiment of a mapping generator system.

FIG. 2 illustrates an embodiment of operations to generate mapping of input nodes in an N-point butterfly network to input nodes of a smaller n-point butterfly network, where n is less than N.

FIG. 3 illustrates an embodiment of a hardware transform units having processing tiles with butterfly units implementing the n-point butterfly network.

FIG. 4 illustrates an example of how the N input nodes are permuted and folded according to the operations of FIG. 2.

FIG. 5 illustrates an example of folding a 16-point radix-2 Singleton transform to an 8-point radix-2 Singleton transform.

FIG. 6 illustrates an example of permuting the rows of nodes for an 8-point Radix-2 Singleton transform.

FIG. 7 illustrates an embodiment of the logic to permute the rows of nodes of folded input nodes.

FIG. 8 illustrates how the input nodes are permuted according to the logic of FIG. 7.

FIG. 9 illustrates an example of folding an 8-point radix-2 Singleton transform to a 4-point radix-2 Singleton transform and then permuting the 4-point radix-2 Singleton transform.

FIG. 10 illustrates an example of folding a 16-point radix-2 Cooley-Tukey transform to a 16-point radix-4 Cooley-Tukey transform and then permuting the 16-point radix-2 Cooley-Tukey transform.

FIG. 11 illustrates an example of folding a 16-point radix-2 Singleton transform to a 8-point radix-2 Singleton transform and then permuting the 8-point radix-2 Singleton transform.

FIG. 12 illustrates an embodiment of a transform system to transform input data.

FIG. 13 illustrates an embodiment of operations to transform input data to output data.

FIG. 14 illustrates an example of how input nodes of a 32-point butterfly network map to different near memory devices.

FIGS. 15, 16, and 17 illustrate embodiments of implementations of the memory device and processing tiles implementing a butterfly network.

FIGS. 18A, 18B, 18C, 18D, 18E, and 18F illustrate an example of how input data from input nodes for a butterfly network are in tiles comprising of the butterfly units and memory devices to produce an identical data layout for each stage of the butterfly network, wherein a memory device comprises of memory banks and buffers.

FIG. 19 illustrates a computing environment in which the components of FIGS. 1 and 12 may be implemented.

### DETAILED DESCRIPTION

Described embodiments provide an algorithm-hardware co-designed approach that enables fast and efficient processing of N-point butterfly networks in near memory. Near-memory processing alleviates the Von Neumann bottleneck, enables faster (low-latency, high-bandwidth) and energy-efficient (pJ/bit) processing without offloading processing off-chip. Described embodiments further provide a mapping scheme that transforms, folds and permutes the butterfly computations of an N-point butterfly network to execute onto a system with M hardware butterfly units (BU), where M<=N. Such embodiments are applicable to the computations of an FFT and other transform algorithms used in signal processing, neural networks, cryptography, which implement one or more sequences of butterfly networks.

In certain embodiments, the nodes in the processing tiles are designed such that the input and output data of each stage of nodes in the butterfly network are identical, to allow for repeatable pipelined execution with minimal reusable interconnects. Further, with described embodiments, the mapping of input nodes to the butterfly units is compatible with all types of memories, such as word-addressable and page-addressable memories.

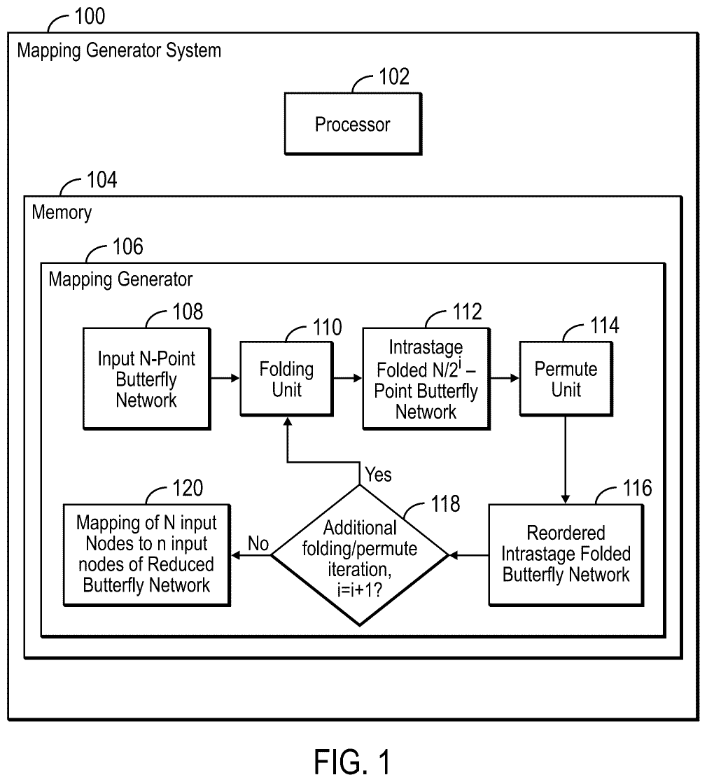

FIG. 1 illustrates a mapping generator system 100 to generate a mapping of the N input nodes of an N-point butterfly network, such as an N-point Radix-k Singleton network to a smaller n-point Radix-k Singleton network, where n is less than N. The radix refers to the number k of input node data processed in each butterfly unit in the processing tiles implementing the n-point radix k butterfly network. The system 100 includes a processor 102 and a memory 104 including a mapping generator 106. The mapping generator 106 receives an input N-point butterfly network 108 of N input nodes and radix k. A folding unit 110 folds or maps the lower half of the N input nodes to the upper half of the N input nodes, to reduce the network to n-input nodes as in a paper fold. Nodes N−1, N−2 . . . . N/2+1 map to nodes 0, 1 . . . . N/2−1, respectively. The folding unit 110 outputs an intrastage N/2ⁱ-point folded butterfly network 112 having N/2ⁱ nodes, where i is the number of iterations of folding performed. The intrastage folded butterfly network 112 provides a mapping of the N input nodes of the input butterfly network 108 to the nodes of the intrastage folded butterfly network 112. A permute unit 114 reorders the rows of the intrastage folded butterfly network 112 to produce a reordered interstage folded butterfly network 116. The mapping generator 106 determines (at block 118) whether to perform an additional iteration of folding and permuting and, if so, forwards the reordered intrastage folded butterfly network 116 to the folding unit 110 to perform an additional (i+1)th iteration of folding and permuting. If (at block 188) there are no additional folding/permute iterations to perform, then the mapping generator 106 outputs a mapping 120 of the N input nodes to the final reduced butterfly network of n input nodes, comprising the reordered intrastage folded butterfly network 116 produced in the final fold and permute iteration.

The mapping generator 106 may generate multiple mappings 120 from transform butterfly networks of different N-points, for different values of N, to the n-point butterfly network that is implemented in a hardware unit to allow transforms performed for different N-point butterfly networks on a hardware unit providing processing tiles to process input data at n input nodes for an n-point butterfly matrix of k Radix.

The memory 104 may comprise a suitable volatile or non-volatile memory devices known in the art to store program components for execution.

Generally, program modules, such as the program components 106, 110, 114 may comprise routines, programs, objects, components, logic, data structures, and so on that perform particular tasks or implement particular abstract data types. The program components and hardware devices of the system 100 may be implemented in one or more computer systems, where if they are implemented in multiple computer systems, then the computer systems may communicate over a network.

The program components 106, 110, 114, among others, may be accessed by the processor 102 from the memory 104 to execute. Alternatively, some or all of the program components 106, 110, 114 may be implemented in separate hardware devices, such as Application Specific Integrated Circuit (ASIC), Field Programmable Gate Arrays (FPGAs) and other hardware devices.

The functions described as performed by the program components 106, 110, 114, among others, may be implemented as program code in fewer program modules than shown or implemented as program code throughout a greater number of program modules than shown.

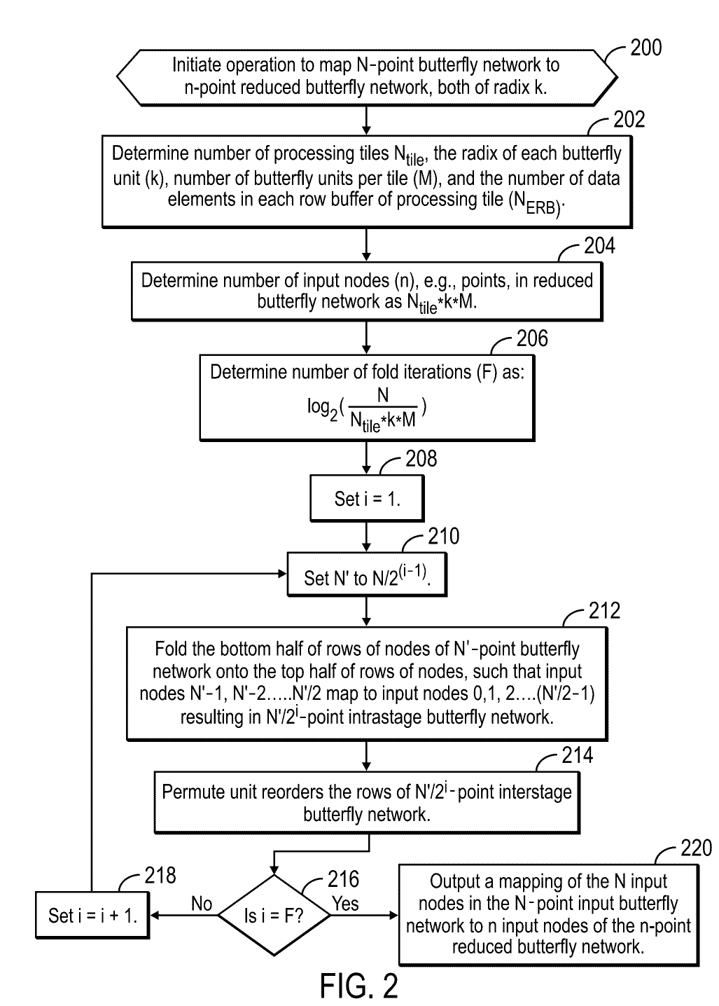

FIG. 2 illustrates an embodiment of operations performed by the mapping generator 106 to generate a mapping of the N input nodes of an input N-point butterfly network 108 to n input nodes of a reduced butterfly network implemented in hardware. Upon initiating (at block 200) the operation to generate the mapping 120, the mapping generator 106 determines (at block 202) a number of processing tiles Nₜᵢₗₑ, in the hardware unit for which the mapping 120 is generated, the radix k, which is a number of the input nodes concurrently processed in each butterfly unit in a processing tile, number of butterfly units per processing tile (M), and the number of data elements in each row buffer of processing tile (N_{ERB}). A determination is made (at block 204) of the number of input nodes (n) in the reduced n-point butterfly network 116 as Nₜᵢₗₑ*k*M. A determination is made (at block 206) of the number of fold and permute iterations (F) according to equation (1) below:

$${log}_{2} ( \frac{N}{{N}_{tile} * k * M} ) \qquad ( 1 )$$

To perform the folding and permute steps, a permutation instance i is set (at block 208) to 1 and a variable N′ is set (at block 210) to N/2ⁱ⁻¹. The folding unit 110 folds (at block 212) the bottom half of rows of nodes of N′-point butterfly network onto the top half of rows of nodes, such that input nodes N′−1, N′−2 . . . . N′/2 map to input nodes 0, 1, 2 . . . . N′/2−1, resulting in an N/2ⁱ-point intrastage butterfly network 112. The permute unit 114 reorders (at block 214) the rows of the input nodes of the N/2ⁱ-point interstage butterfly network 112 producing the reordered N/2ⁱ-point interstage butterfly network 116. If (at block 216) i is not equal to F, i.e, more folding/permute iterations are to be performed, then i is incremented (at block 218) and control proceeds back to block 210 to perform another iteration of fold and permute operations on the network to further reduce the number of input nodes to the hardware transform unit. If (at block 216) i is equal to F, the mapping generator 106 outputs (at block 220) a mapping 120 of the N input nodes in the N-point input butterfly network to n input nodes of the n-point reduced butterfly network, comprising the final reordered intrastage folded butterfly network 116, where n equals last computed instance of N′.

With the embodiment of operations of FIG. 2, the mapping generator 106 may generate a mapping to map an N-point butterfly network to fewer n input nodes of an n-point butterfly network implemented in hardware, to allow input data for a large sized butterfly network to be processed on hardware implementing a smaller point butterfly network. This allows a hardware unit of processing tiles to process input data for different N-point butterfly networks for different values of N.

Further, in certain embodiments, the mapping generator 106 that performs iterative paper-like folds and permute is specifically designed for near memory operations. Further, the mapping generator 106 may convert a linear transform into a Singleton mapping structure.

The described embodiment transforms and mapping 120 for transforms may be used to perform different types of transform operations, including, but not limited to, a Discrete Fourier Transform (DFT), Discrete Cosine Transform (DCT), Discrete Sine Transform (DST), Hadamard Transform, Fastfood, Orthogonal random features, sparse, low rank circulant, Toeplitz-like, ACDC, low displacement rank LDF, Hankel Vandermonde, Cauchy+variants, orthogonal polynomial transforms, and semiseparable, quasiseparable+variants. The transforms for which the mapping 120 is provided may be used for applications including signal processing and feature extraction, dimensionality reduction, kernel approximation, neural network model compression, partial differential equations, computer algebra, etc.

Although embodiments are described with respect to mapping an N-point butterfly network to an n-point butterfly network, the described embodiments for mapping nodes may apply to transform networks other than butterfly networks.

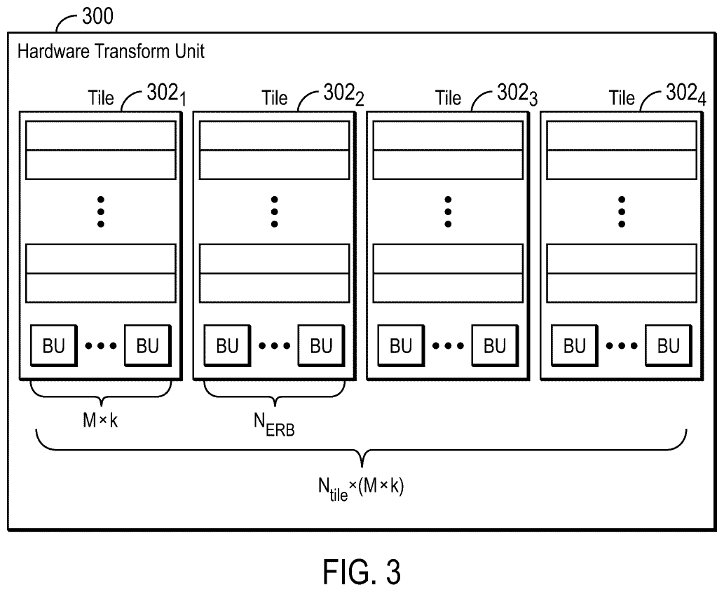

FIG. 3 shows an example of a hardware transform unit 300 including processing tiles 302₁, 302₂, 302₃, 302₄ to illustrate how a tile 302ᵢ includes M butterfly units, labeled “BU”, each of radix k, to process input data from k input nodes in each butterfly unit. A processing tile, also known as a processing element or processing unit, includes a processor, memory, and implementation of butterfly units to perform butterfly network processing operations. The number of data elements, or input data from the N input nodes, concurrently consumed in a stage of nodes in a tile 302ᵢ comprises k*M. The total number of data elements N_{ERB} the memory can store at each row in a tile 302ᵢ, i.e., the size of the row buffer, is greater than or equal to M*k. Nₜᵢₗₑ*(M*k) would be the total number of data elements processed across the tiles 300; at a time.

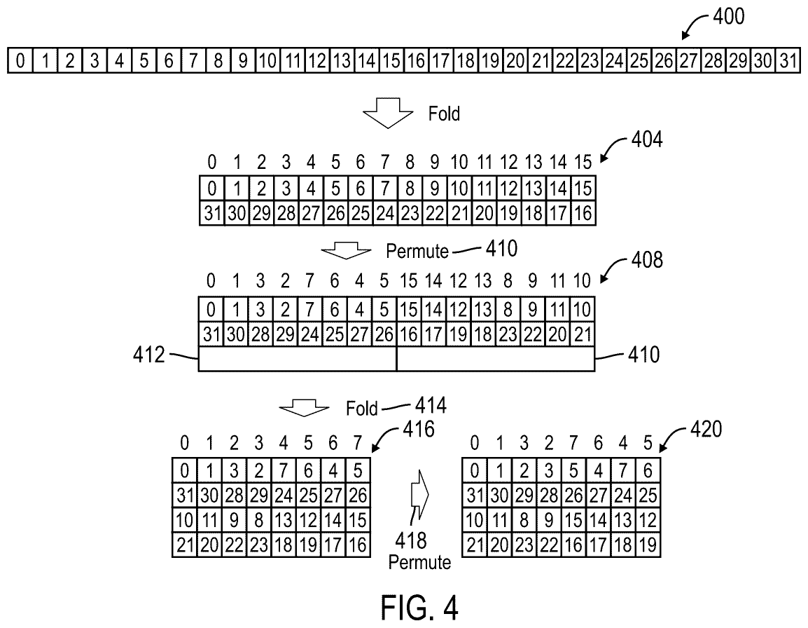

FIG. 4 provides an example of the fold and permute operations of FIG. 2 on an input 32-point butterfly network having input nodes 400 according, i.e., N=32 and n=8. A first fold operation 402 produces the folded mapping 404 showing how the lower half of the 32 input nodes, nodes 16-31 map to the upper half of the 32 input nodes, nodes 0-15, such that nodes 31-16 map to nodes 0-15, respectively. The rows of the folded input nodes 404 are then reordered/permuted 406 as shown in the reordered and folded input nodes 408. A second fold operation 414 is performed on the reordered and folded input nodes 408 to map the lower half 410 of the input nodes 408 to the upper half 412 of the input nodes 408, to produce a further folded eight input node mapping 416 having 8 input nodes for an 8-point butterfly network. The second folded input nodes 416 are permuted 418 to produce the reordered second folded input nodes 420.

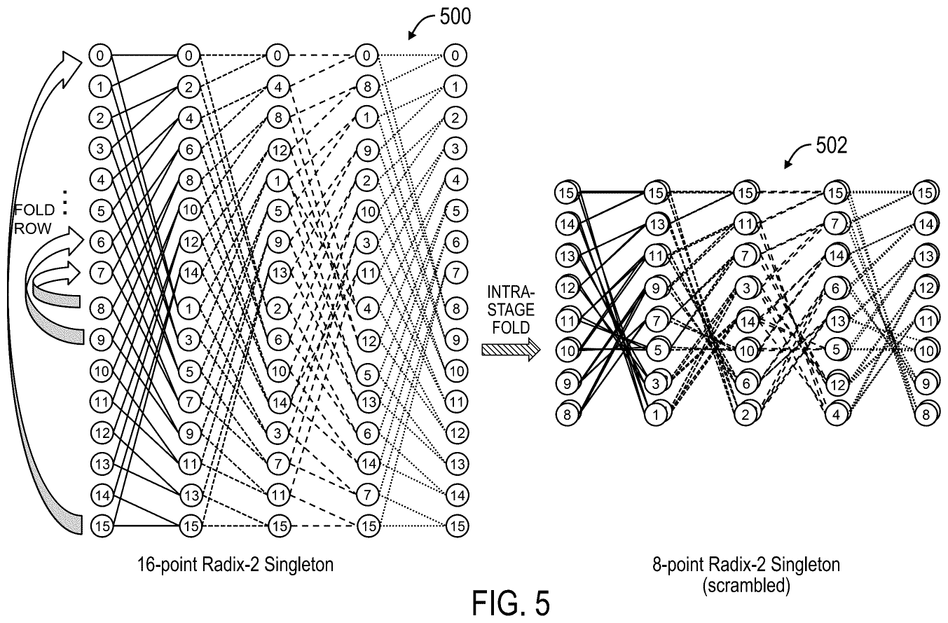

FIG. 5 illustrates an example, according to described embodiments, of how the nodes in a 16-point butterfly network 500 are folded into a folded 8-point butterfly network 502. The lowest row of nodes is folded to the first row of nodes in the butterfly network, or in a 16-point butterfly network, nodes 15-8 are folded onto nodes 0-7, respectively.

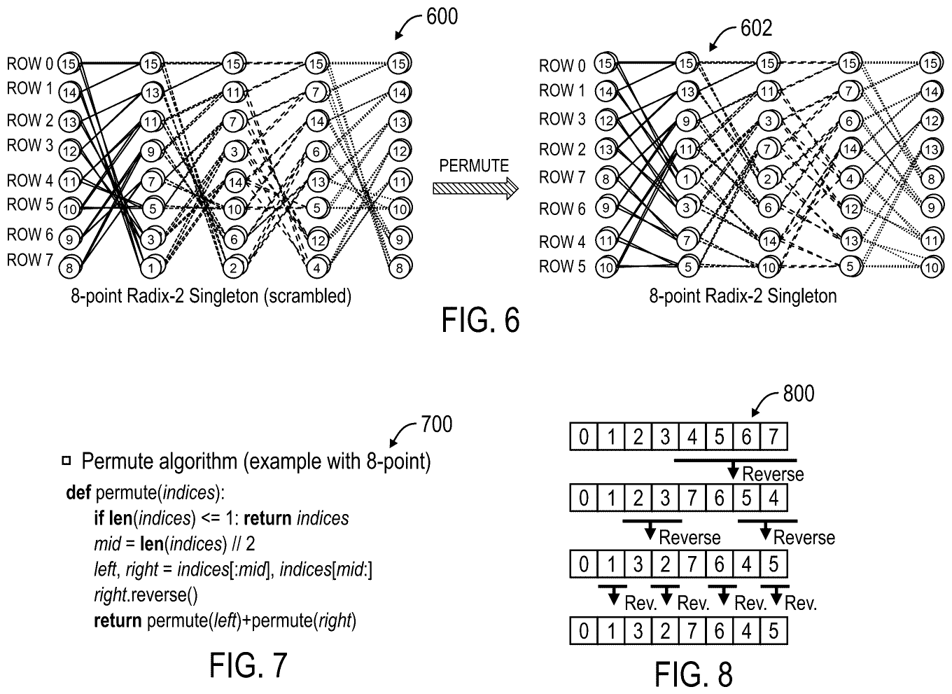

FIG. 6 further illustrates an example of a folded 8-point butterfly network 600 that is permuted to produce the reordered 8-point butterfly network 602.

FIG. 7 illustrates an embodiment of the permute unit 114 algorithm 700 to reorder the input nodes, where indices are the number nodes being considered of the eight input nodes. The algorithm 700 splits the number of nodes into left and right nodes, each comprising half the nodes, and reverses the order of nodes in the right half of the split nodes. The algorithm 700 further recursively does this split of the nodes on the left half and right half of the nodes to further reverse the right nodes, until the recursion unit has just two nodes. Other algorithms known in the art may be used to reorder/permute the input nodes.

FIG. 8 illustrates an example, according to described embodiments, of how eight input nodes 800 are reordered using the algorithm of FIG. 7 to reverse the right half of the nodes, and then recursively perform the reversal operation on each half of nodes until there are only two nodes in a half to consider for reversal.

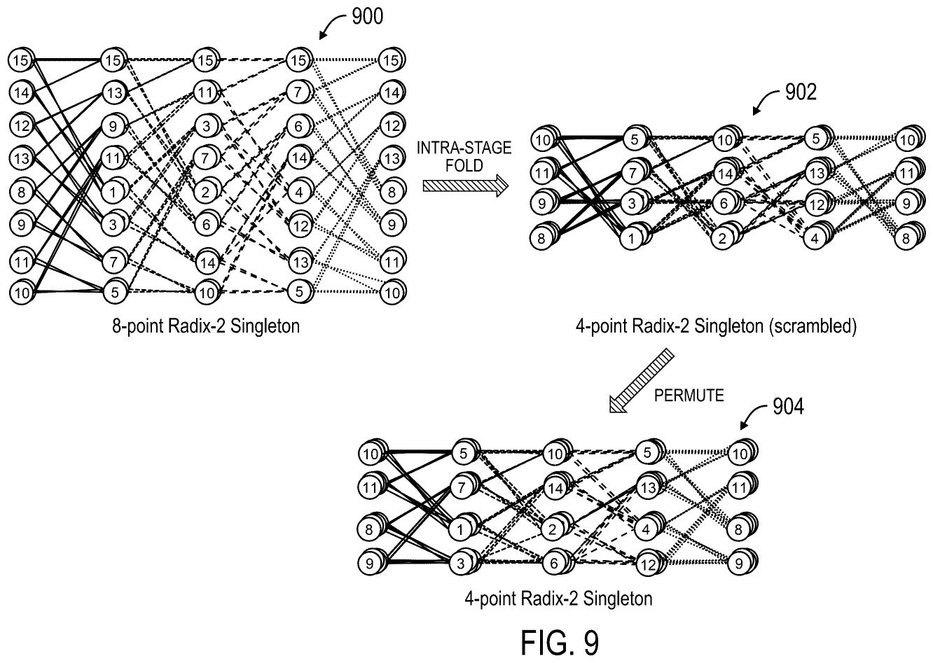

FIG. 9 illustrates an example, according to described embodiments, of how an 8-point butterfly network 900 is folded into a 4-point butterfly network 902, and how the 4-point butterfly network 902 is permuted to a reordered 4-point butterfly network 904.

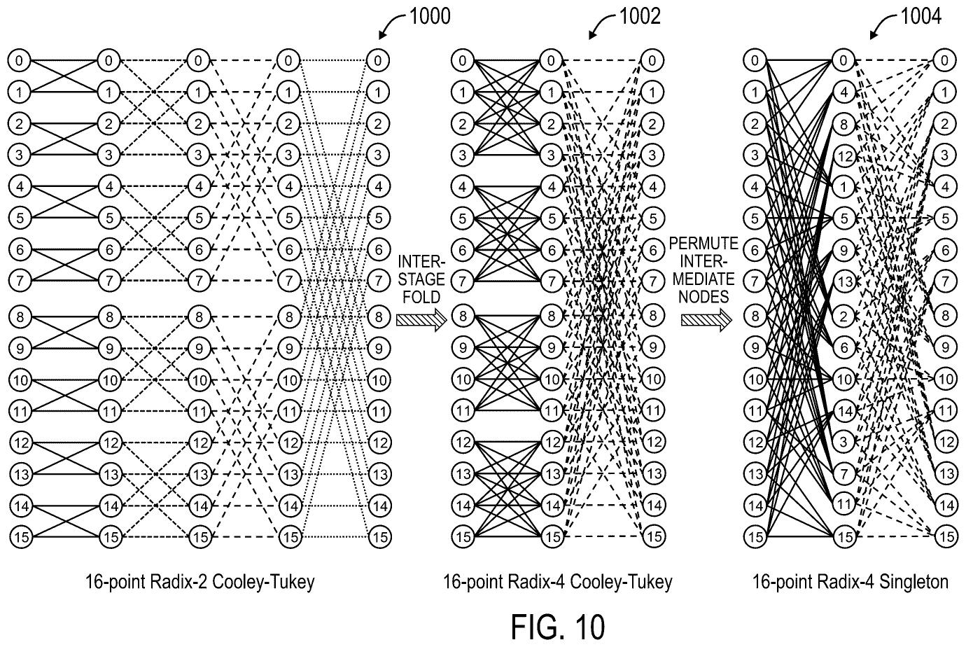

FIG. 10 illustrates an example of an alternative embodiment of folding, not to reduce number of input nodes, but to reduce number of stages of processing in the network, where a 16-point radix-2 Cooley-Tukey 1000 is folded to reduce the number of stages and increase the radix to a two-stage 16-point Radix-4 Cooley-Tukey network 1002. The reduced stage folded network 1002 is permuted to the reordered reduced-stage 16-point radix-4 Singleton network 1004.

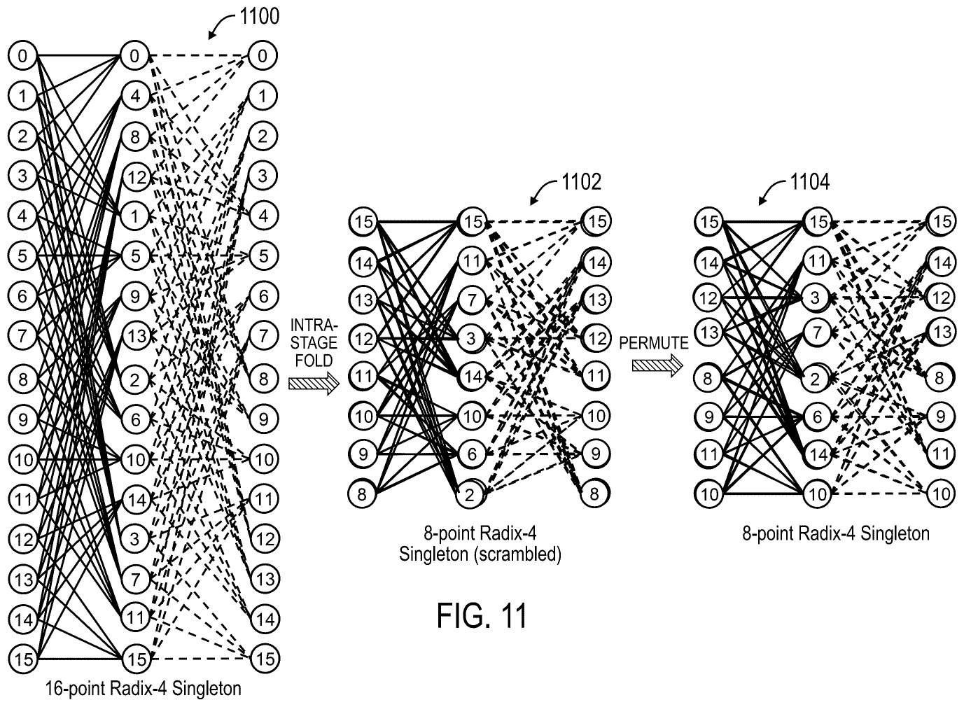

FIG. 11 illustrates an example, according to described embodiments, of folding a 16-point radix-4 Singleton network 1100 into an 8-point Radix-4 Singleton network 1102, and then permuting the network 1102 into a reordered 8-point radix-4 Singleton network.

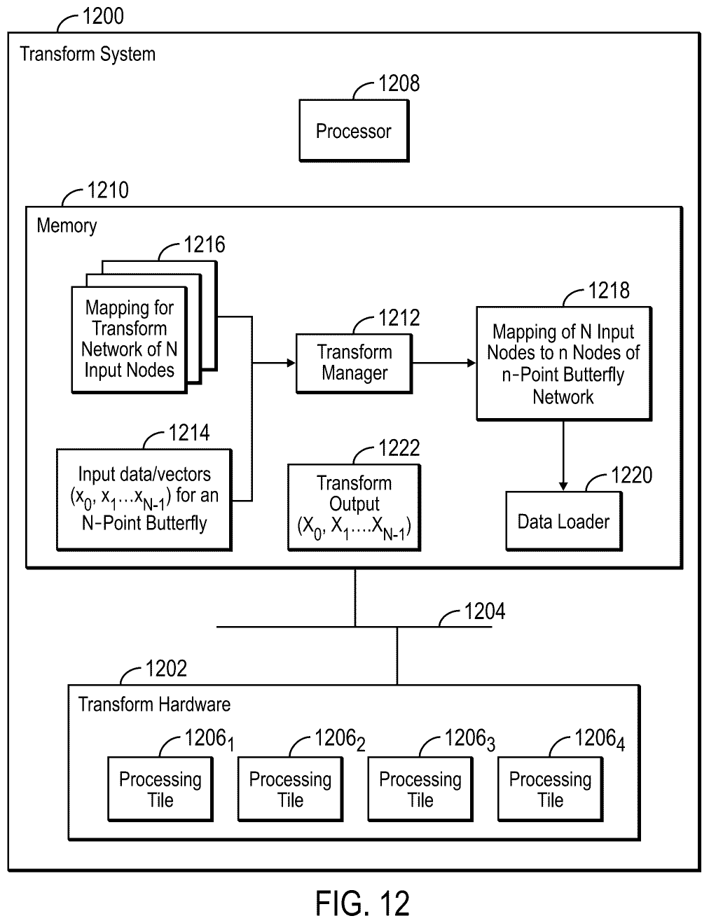

FIG. 12 illustrates an embodiment of a transform system 1200 coupled to transform hardware 1202 over a bus interface 1204 to perform an N-point butterfly network transform using the mapping 120 of the N-point butterfly network to an n-point butterfly network for transform hardware 1202 implementing the n-point butterfly network, where n is less than N. The transform hardware 1202 includes a plurality of processing tiles 12061, 12062, 12063, 12064, that each include M butterfly units to process a number of data elements M*k from the N nodes for the N-point network. Although four processing tiles are shown, there may be any number of processing tiles for different radix and input node butterfly network configurations.

The system 1200 includes a processor 1208 and a memory 1210 including a transform manager 1212 that receives input data (x₀, x₁, x₂ . . . x_{N}) for an N-Point butterfly network 1214 and selects a mapping 1216, such as a generated mapping 120, to generate a mapping 1218 of the N input nodes from the received input data 1214 to n nodes of an n-point butterfly network implemented in the transform hardware 1202. A data loader 1220 loads the n nodes of data into a near memory device for the tiles 1206₁, 1206₂, 1206₃, 1206₄ to process the input data at the M butterfly units in each tile 1206ᵢ to produce transform output 1222, e.g., (X₀, X1 . . . . X_{N-1}). The output 1222 may then be used in further processing.

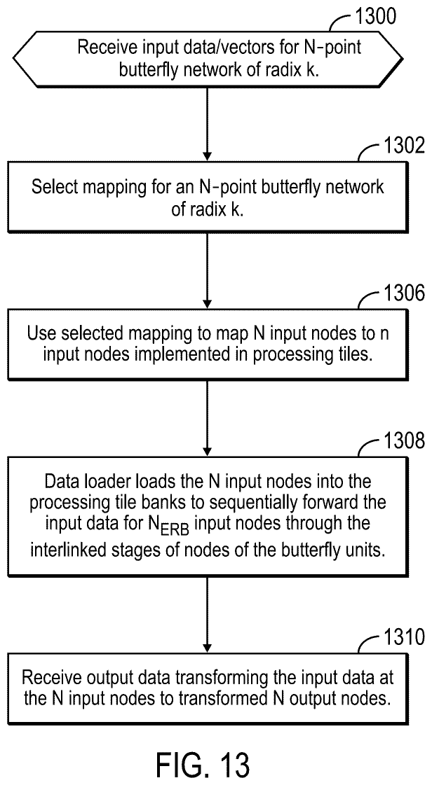

FIG. 13 illustrates an embodiment of operations performed by the transform manager 1212 to process received (at block 1300) input data/vectors for an N-point butterfly matrix to map to n nodes of an n-point butterfly matrix for processing by the processing tiles 1206; in the transform hardware 1202. The transform manager 1212 selects (at block 1302) a mapping 1216 for the N-point butterfly network of radix k to the smaller n-point butterfly network. The transform manager 1212 uses (at block 1306) the selected mapping 1216 to map the N input nodes to n input nodes implemented in processing tiles 1206ᵢ. The data loader 1220 loads (at block 1308) the N input nodes into the processing tile banks to sequentially forward the input data or elements for N_{ERB} input nodes through the interlinked stages of nodes of the butterfly units. Output 1222 is received (at block 1310) from the processing tiles comprising the transformed data (X₀, X₁, X₂ . . . . X_{N-1}) from the input data (x₀, x₁ . . . x_{N-1}) for the N input nodes.

With the embodiment of FIG. 13, the mappings of a larger butterfly network to a smaller butterfly network are used to map input data for the larger butterfly network to nodes for the smaller butterfly network implemented in transform hardware 1202 to allow the same transform hardware 1202 to process input data for different sized butterfly networks, and optimize the use of hardware for different butterfly network configurations.

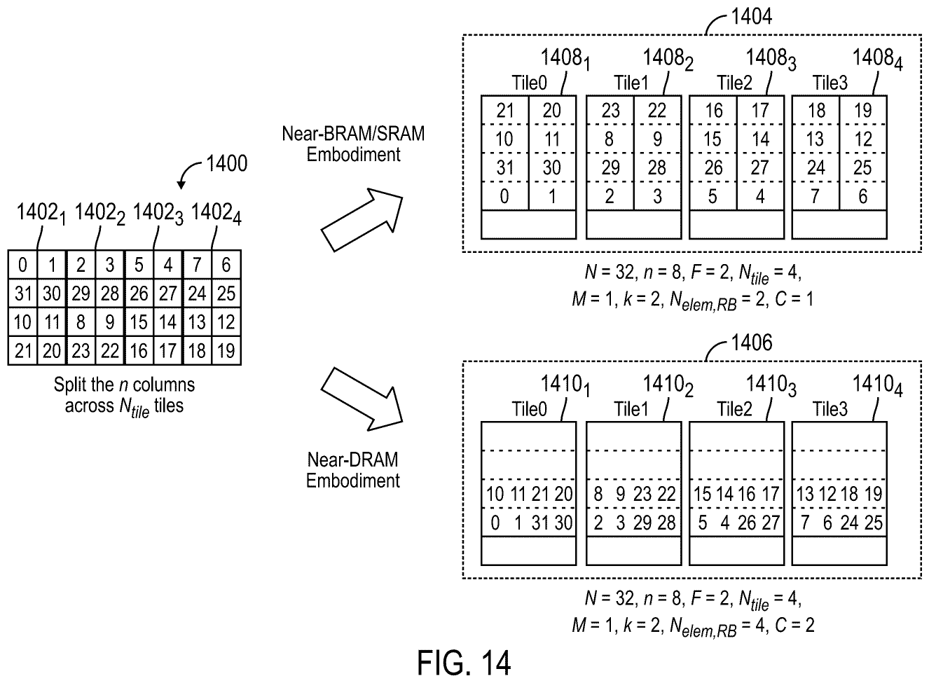

FIG. 14 illustrates an example of how eight columns 1400 of input data for the 32 nodes of a 32-point butterfly network are split across the four tiles (Nₜᵢₗₑ). The input nodes of the 32-point butterfly network map to eight nodes of the folded 8-point butterfly network, where each pair of columns 1402₁, 1402₂, 1402₃, 1402₄ of eight nodes of the 32-point butterfly network are processed by one of the four shown tiles Tile0, Tile1, Tile2, Tile3, respectively. Eight input nodes of the 32-point butterfly network map to each node of the folded 8-point butterfly network implemented in the tiles.

Two embodiments are shown for the near memory devices buffering the input data for the columns 1402₁, 1402₂, 1402₃, 1402₄ of input nodes for the four tiles, including a near Block Random Access Memory (BRAM)/Static Random Access Memory (SRAM) 1404 and a near Dynamic Random Access Memory (DRAM) 1406.

In the BRAM/SRAM 1404 embodiment, each of the two columns 1402₁, 1402₂, 1402₃, 1402₄ of input data for eight nodes are buffered in two columns of four rows in buffers of 1408₁, 1408₂, 1408₃, 1408₄ in the BRAM/SRAM 1404 for the four tiles. In the near-DRAM embodiment 1406, each of the two columns 1402₁, 1402₂, 1402₃, 1402₄ of input data for eight nodes are buffered in two rows of buffers 1410₁, 1410₂, 1410₃, 1410₄ in the DRAM 1406 for the four tiles.

Further, in one embodiment, to distribute the n columns into Nₜᵢₗₑ tiles, the columns are split into continuous chunks of n/Nₜᵢₗₑ=M*k. Each row of these chunks of input of size M*k is filled into the memory (BRAM/SRAM/DRAM) of the respective tile. Each of M*k chunks of data can be stored in the memory in any order, if the same order is followed for every tile.

In FIG. 14, for the near memories 1404, 1406, N comprises the points in the input butterfly network, which in the example of 32, n comprises the points in the folded butterfly network, F comprises the number of folds, Nₜᵢₗₑ comprises the number of tiles in the transform hardware, M comprises the number of butterfly units in each tile, k comprises the radix, N_{ERB} comprises the number of elements in each row of the buffer, which are two for near memory 1404 and four for near memory 1406, and C comprises (N_{ERB})/(k*M).

FIG. 14 provides near memory 1404, 1406 processing that leverages the tight density of DRAM cells, and high-density SRAM technologies, such as stacked vertical SRAM, thereby enabling up to several gigabytes or even terabytes of memory capacity that is used directly for computation. Further, utilizing a Singleton butterfly dataflow allows processing of all of the butterfly stages with the same compute unit and compute unit connections. This obviates the need for an all-to-all connections between the compute units, or a transposition network.

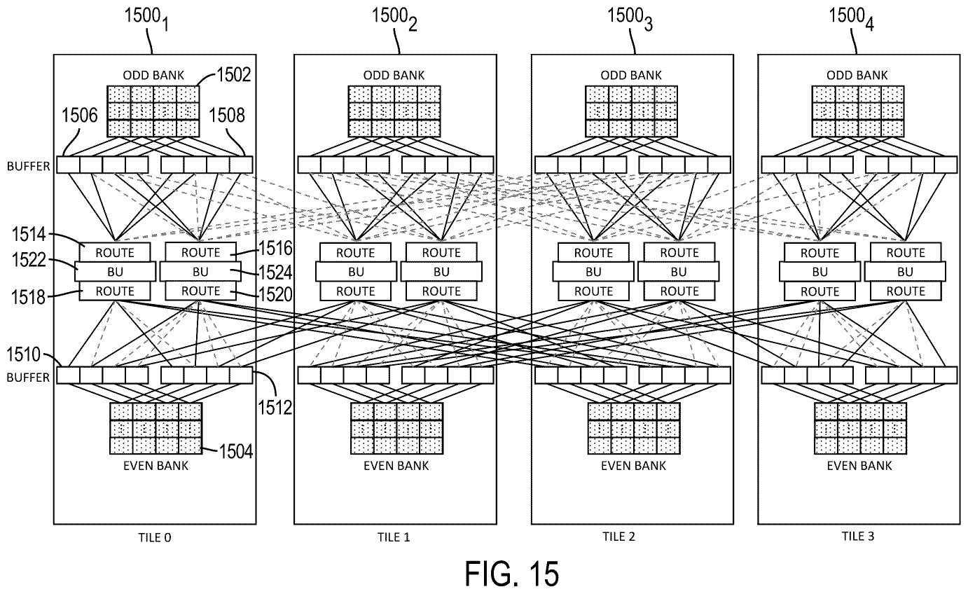

FIG. 15 shows a further embodiment of the arrangement of the processing tiles 1500₁, 1500₂, 1500₃, 1500₄. Each of the processing tiles 1500ᵢ includes, as described with respect to processing tile 1500₁, an odd bank 1502 and an even bank 1504 to buffer input data from input node indices at odd or even stages of the butterfly network, respectively. The node data for different of the N input nodes are moved from the banks 1502, 1504 to the buffers 1506, 1508, 1510, 1512 in a near memory device, as shown in FIG. 14, and from there routed by routers 1514, 1516, 1518, 1520 to butterfly units 1522, 1524. The butterfly units 1522, 1524 receive data from buffers in the other processing tiles 1500j during the interlinked stage processing at the nodes in the butterfly units 1522, 1524.

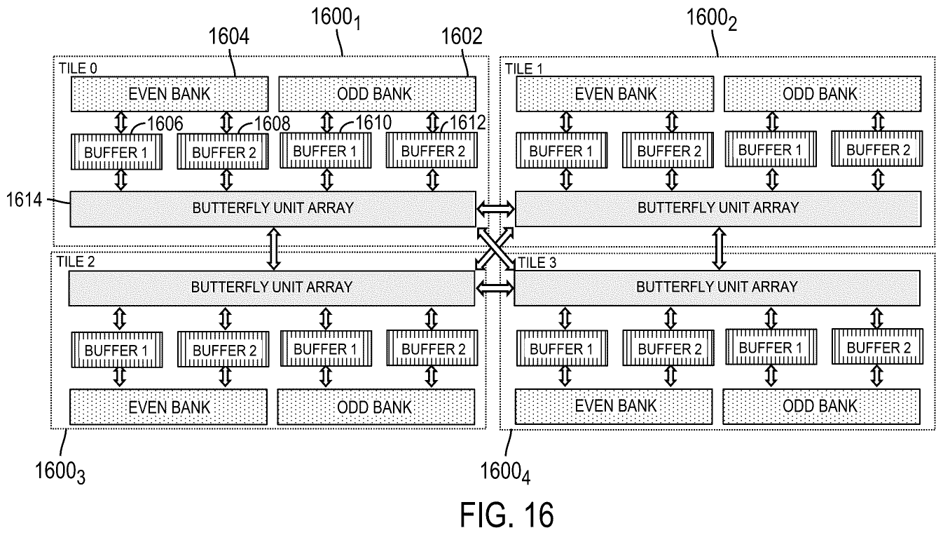

FIG. 16 illustrates a further embodiment of the arrangement of the processing tiles 1600₂, 1600₂, 1600₃, 1600₄. Each of the processing tiles 1600ᵢ includes, as described with respect to processing tile 16001, an odd bank 1602 and an even bank 1504 to buffer input data from input node indices having odd or even values, respectively. The node data for different of the N input nodes are moved from the banks 1602, 1604 to the buffers 1606, 1608, 1610, 1612 in near memory devices, as shown in FIG. 14, and then from there to a butterfly unit array 1614. The butterfly unit arrays of the processing tiles are interconnected to allow exchange of data from the input nodes among the tiles 1600₂, 1600₂, 1600₃, 1600₄.

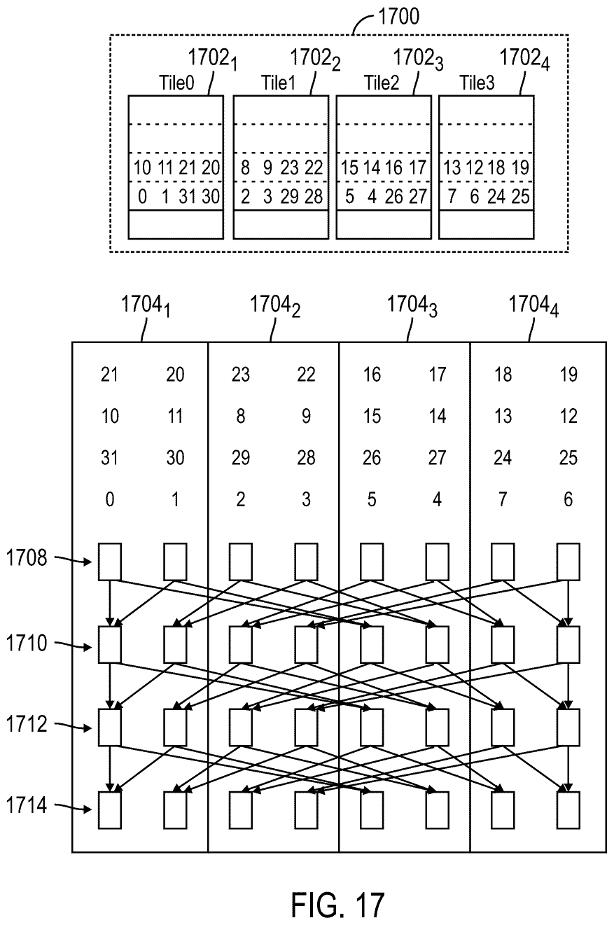

FIG. 17 illustrates an embodiment of a near memory device 1700, such as the near memory device 1406 of FIG. 14, having buffers 1702₁, 1702₂, 1702₃, 1702₄ for the tiles 1704₁, 1704₂, 1704₃, 1704₄. Each buffer 1702ᵢ stores data from 8 input nodes of the 32-point butterfly network in two rows of the buffer 1702ᵢ, such as shown in the near memory device 1406 of FIG. 14. The data in the two rows of the buffers 1702ᵢ are then inputted into the tiles 1704ᵢ as shown. Each of the tiles 1704ᵢ includes include stages of nodes 1708, 1710, 1712, 1714 to process data from two input nodes in the row buffers of the buffer 1702ᵢ for the tile 1704ᵢ. The tiles 1704ᵢ show how pairs of input data from the row buffers in the buffers 1702ᵢ are loaded into the processing nodes of the tile 1704ᵢ.

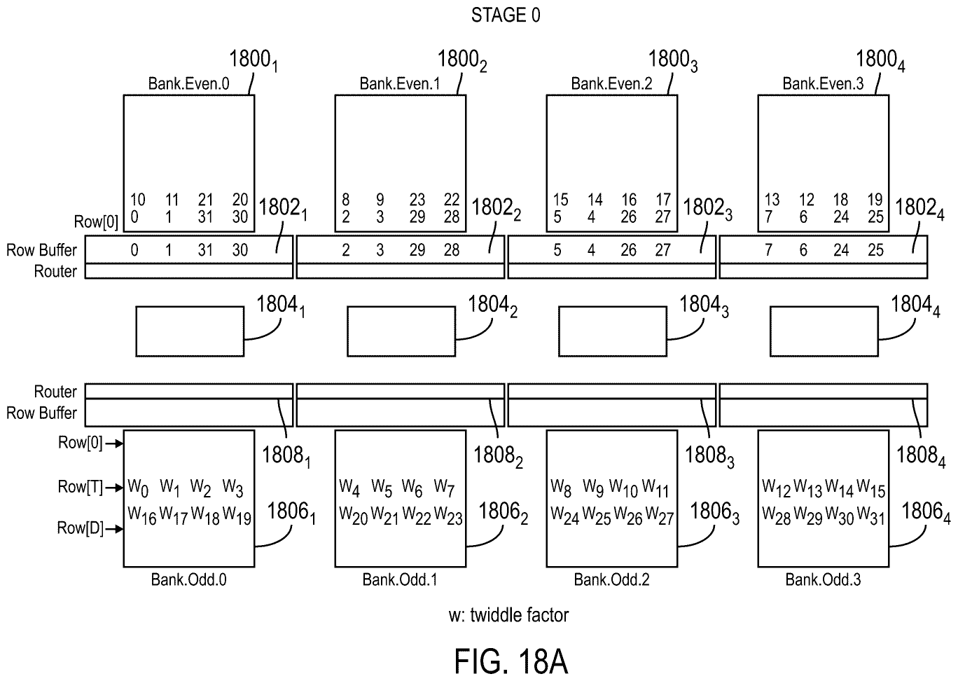

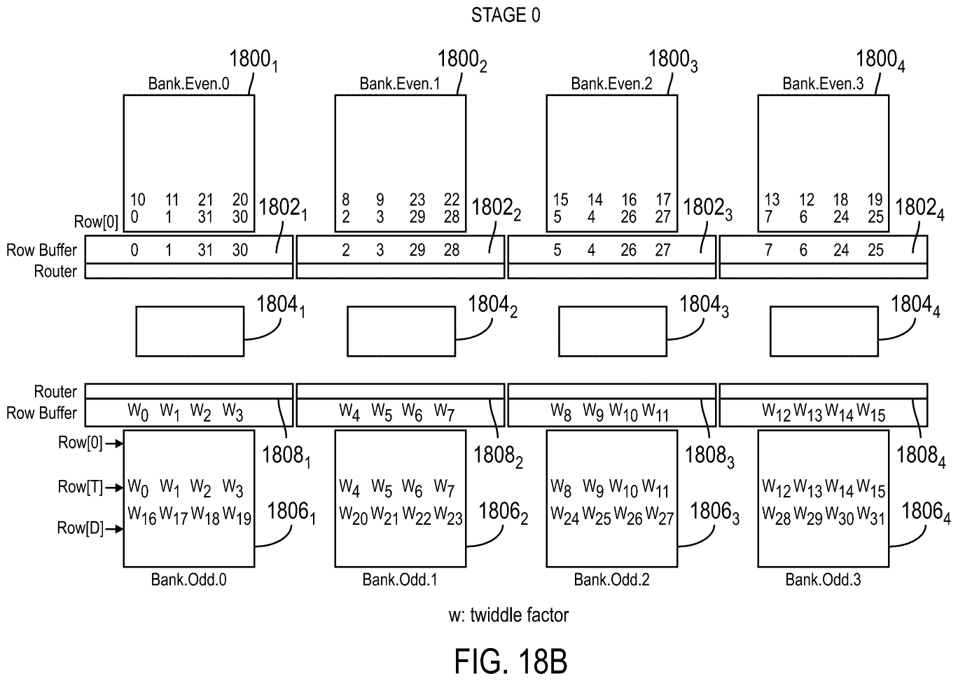

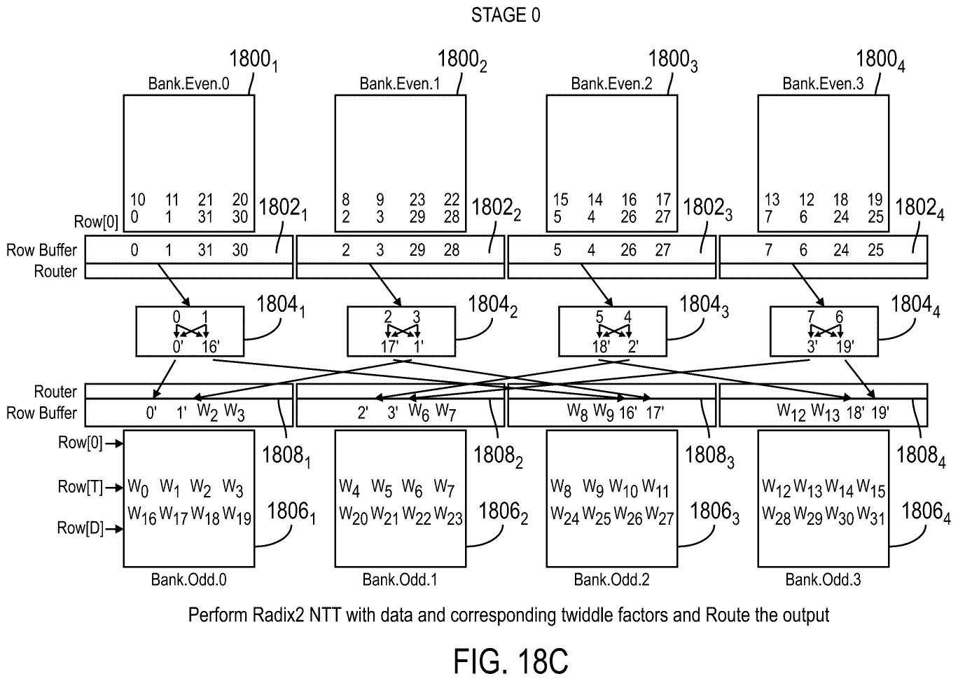

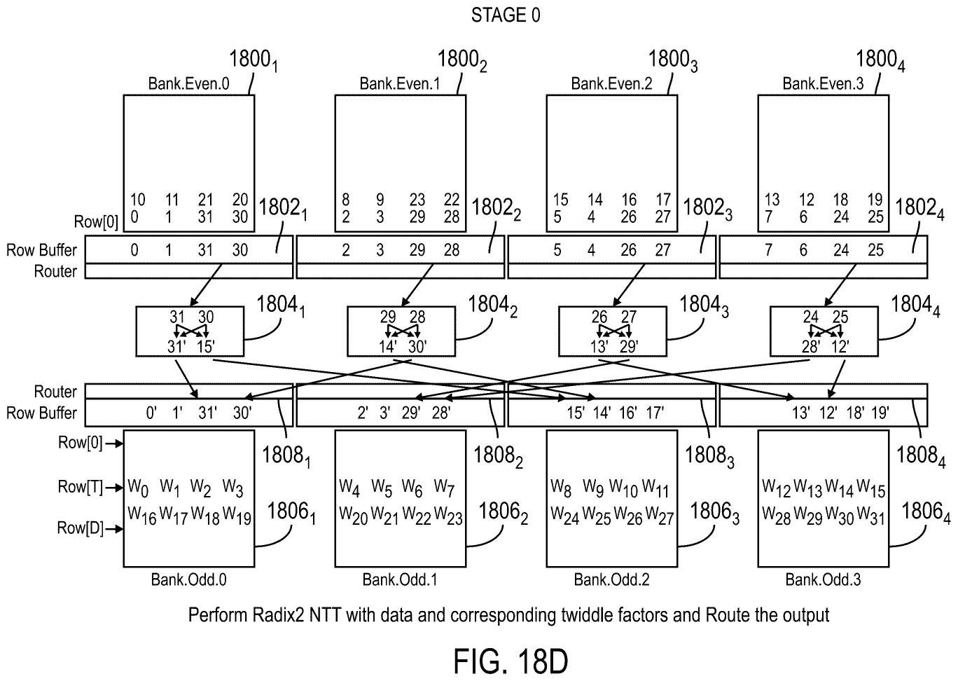

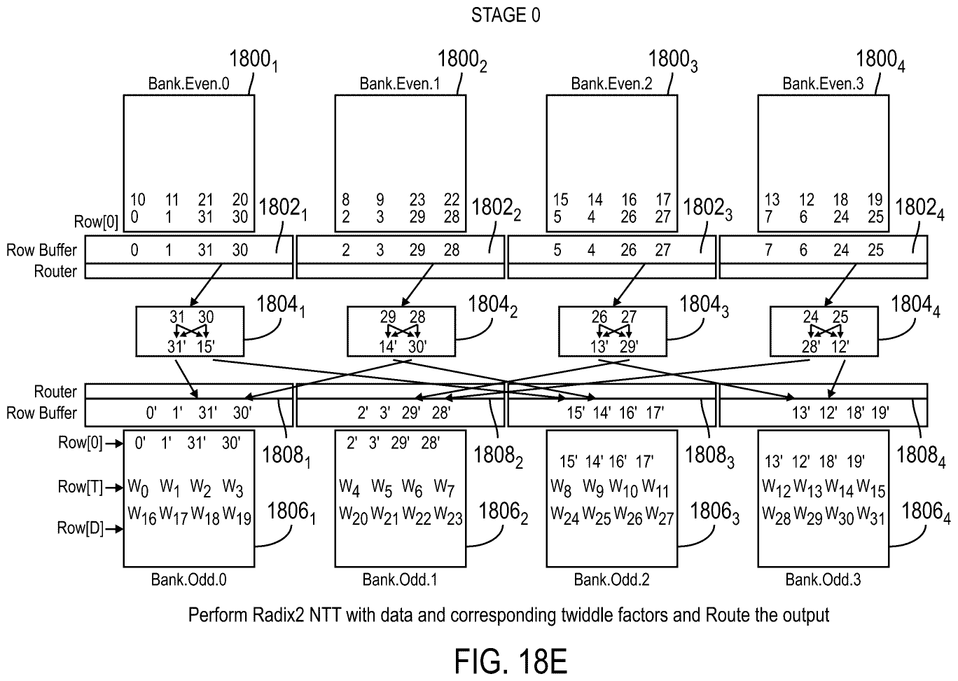

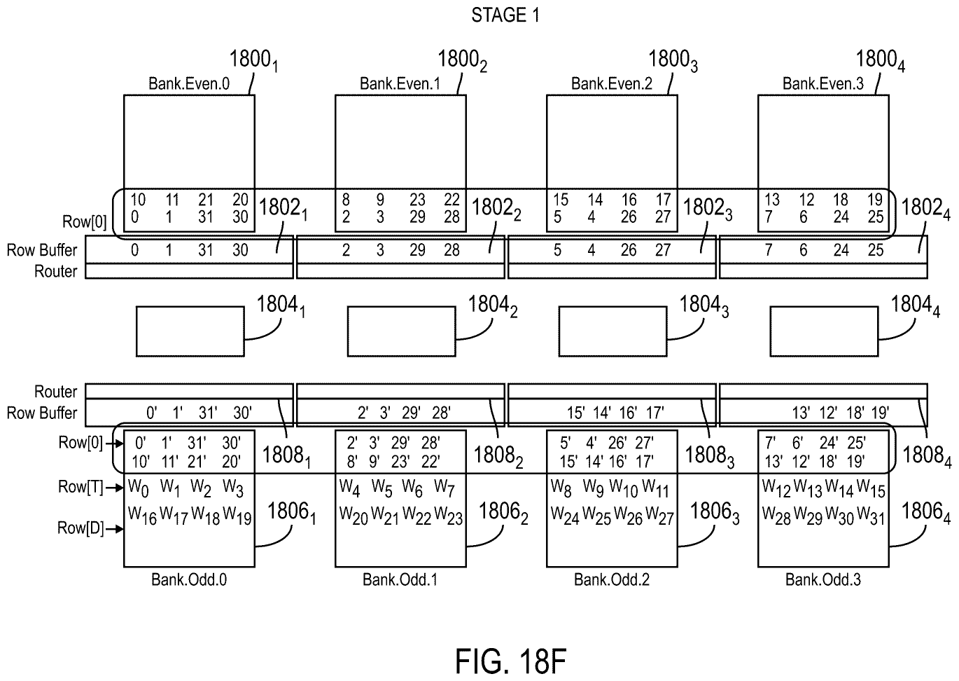

FIGS. 18A, 18B, 18C, 18D, 18E, and 18F, provide an embodiment of the progression of how rows of input data in the banks 1800₁, 1800₂, 1800₃, 1800₄ flow through the row buffers 1802₁, 1802₂, 1802₃, 1802₄ to the butterfly units 1804₁, 1804₂, 1804₃, 1804₄. Odd banks 1806₁, 1806₂, 1806₃, 1806₄ include twiddle values (Wᵢ) that are used along with the inputs in the even banks 1800₁, 1800₂, 1800₃, 1800₄, by the butterfly units 1804₁, 1804₂, 1804₃, 1804₄ to generate the outputs in the odd banks. With the embodiment of FIGS. 18a . . . 18F, the mapping produces an identical data layout for each stage of the butterfly network.

With the embodiments of FIGS. 15, 16, 17, and 18A, 18B, 18C, 18D, 18E, and 18F, the bank-to-bank connections are designed to accelerate the mapped butterfly algorithm.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

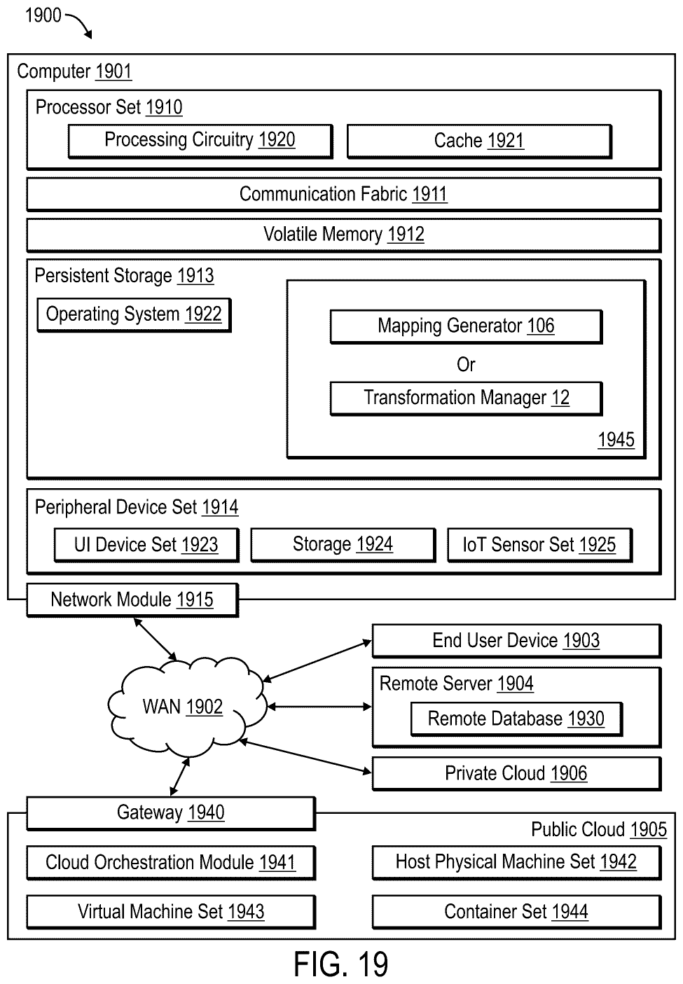

With respect to FIG. 19, computing environment 1900 contains an example of an environment for the execution of at least some of the computer code involved in performing the inventive methods, such as the mapping generator 106 of FIG. 1 or the transform manager 12 of FIG. 12 in block 1945. In addition to block 945, computing environment 1900 includes, for example, computer 1901, wide area network (WAN) 1902, end user device (EUD) 1903, remote server 1904, public cloud 1905, and private cloud 1906. In this embodiment, computer 1901 includes processor set 1910 (including processing circuitry 1920 and cache 1921), communication fabric 1911, volatile memory 1912, persistent storage 1913 (including operating system 1922 and block 945, as identified above), peripheral device set 1914 (including user interface (UI) device set 1923, storage 1924, and Internet of Things (IoT) sensor set 1925), and network module 1915. Remote server 1904 includes remote database 1930. Public cloud 1905 includes gateway 1940, cloud orchestration module 1941, host physical machine set 1942, virtual machine set 1943, and container set 1944.

COMPUTER 1901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1930. As is well understood in the art of computer technology, and depending upon the technology, performance of a computer-implemented method may be distributed among multiple computers and/or between multiple locations. On the other hand, in this presentation of computing environment 1900, detailed discussion is focused on a single computer, specifically computer 1901, to keep the presentation as simple as possible. Computer 1901 may be located in a cloud, even though it is not shown in a cloud in FIG. 19. On the other hand, computer 1901 is not required to be in a cloud except to any extent as may be affirmatively indicated.

PROCESSOR SET 1910 includes one, or more, computer processors of any type now known or to be developed in the future. Processing circuitry 1920 may be distributed over multiple packages, for example, multiple, coordinated integrated circuit chips. Processing circuitry 1920 may implement multiple processor threads and/or multiple processor cores. Cache 1921 is memory that is located in the processor chip package(s) and is typically used for data or code that should be available for rapid access by the threads or cores running on processor set 1910. Cache memories are typically organized into multiple levels depending upon relative proximity to the processing circuitry. Alternatively, some, or all, of the cache for the processor set may be located “off chip.” In some computing environments, processor set 1910 may be designed for working with qubits and performing quantum computing.

Computer readable program instructions are typically loaded onto computer 1901 to cause a series of operational steps to be performed by processor set 1910 of computer 1901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1921 and the other storage media discussed below. The program instructions, and associated data, are accessed by processor set 1910 to control and direct performance of the inventive methods. In computing environment 1900, at least some of the instructions for performing the inventive methods may be stored in block 945 in persistent storage 1913.

COMMUNICATION FABRIC 1911 is the signal conduction path that allows the various components of computer 1901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1912 is any type of volatile memory now known or to be developed in the future. Examples include dynamic type random access memory (RAM) or static type RAM. Typically, volatile memory 1912 is characterized by random access, but this is not required unless affirmatively indicated. In computer 1901, the volatile memory 1912 is located in a single package and is internal to computer 1901, but, alternatively or additionally, the volatile memory may be distributed over multiple packages and/or located externally with respect to computer 1901.

PERSISTENT STORAGE 1913 is any form of non-volatile storage for computers that is now known or to be developed in the future. The non-volatility of this storage means that the stored data is maintained regardless of whether power is being supplied to computer 1901 and/or directly to persistent storage 1913. Persistent storage 1913 may be a read only memory (ROM), but typically at least a portion of the persistent storage allows writing of data, deletion of data and re-writing of data. Some familiar forms of persistent storage include magnetic disks and solid state storage devices. Operating system 1922 may take several forms, such as various known proprietary operating systems or open source Portable Operating System Interface-type operating systems that employ a kernel. The code included in block 945 typically includes at least some of the computer code involved in performing the inventive methods.

PERIPHERAL DEVICE SET 1914 includes the set of peripheral devices of computer 1901. Data communication connections between the peripheral devices and the other components of computer 1901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1923 may include components such as a display screen, speaker, microphone, wearable devices (such as goggles and smart watches), keyboard, mouse, printer, touchpad, game controllers, and haptic devices. Storage 1924 is external storage, such as an external hard drive, or insertable storage, such as an SD card. Storage 1924 may be persistent and/or volatile. In some embodiments, storage 1924 may take the form of a quantum computing storage device for storing data in the form of qubits. In embodiments where computer 1901 is required to have a large amount of storage (for example, where computer 1901 locally stores and manages a large database) then this storage may be provided by peripheral storage devices designed for storing very large amounts of data, such as a storage area network (SAN) that is shared by multiple, geographically distributed computers. IoT sensor set 1925 is made up of sensors that can be used in Internet of Things applications. For example, one sensor may be a thermometer and another sensor may be a motion detector.

NETWORK MODULE 1915 is the collection of computer software, hardware, and firmware that allows computer 1901 to communicate with other computers through WAN 1902. Network module 1915 may include hardware, such as modems or Wᵢ-Fi signal transceivers, software for packetizing and/or de-packetizing data for communication network transmission, and/or web browser software for communicating data over the internet. In some embodiments, network control functions and network forwarding functions of network module 1915 are performed on the same physical hardware device. In other embodiments (for example, embodiments that utilize software-defined networking (SDN)), the control functions and the forwarding functions of network module 1915 are performed on physically separate devices, such that the control functions manage several different network hardware devices. Computer readable program instructions for performing the inventive methods can typically be downloaded to computer 1901 from an external computer or external storage device through a network adapter card or network interface included in network module 1915.

WAN 1902 is any wide area network (for example, the internet) capable of communicating computer data over non-local distances by any technology for communicating computer data, now known or to be developed in the future. In some embodiments, the WAN 1902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1903 is any computer system that is used and controlled by an end user (for example, a customer of an enterprise that operates computer 1901), and may take any of the forms discussed above in connection with computer 1901. EUD 1903 typically receives helpful and useful data from the operations of computer 1901. For example, in a hypothetical case where computer 1901 is designed to provide a recommendation to an end user, this recommendation would typically be communicated from network module 1915 of computer 1901 through WAN 1902 to EUD 1903. In this way, EUD 1903 can display, or otherwise present, the recommendation to an end user. In some embodiments, EUD 1903 may be a client device, such as thin client, heavy client, mainframe computer, desktop computer and so on.

REMOTE SERVER 1904 is any computer system that serves at least some data and/or functionality to computer 1901. Remote server 1904 may be controlled and used by the same entity that operates computer 1901. Remote server 1904 represents the machine(s) that collect and store helpful and useful data for use by other computers, such as computer 1901. For example, in a hypothetical case where computer 1901 is designed and programmed to provide a recommendation based on historical data, then this historical data may be provided to computer 1901 from remote database 1930 of remote server 1904.

PUBLIC CLOUD 1905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1905 is performed by the computer hardware and/or software of cloud orchestration module 1941. The computing resources provided by public cloud 1905 are typically implemented by virtual computing environments that run on various computers making up the computers of host physical machine set 1942, which is the universe of physical computers in and/or available to public cloud 1905. The virtual computing environments (VCEs) typically take the form of virtual machines from virtual machine set 1943 and/or containers from container set 1944. It is understood that these VCEs may be stored as images and may be transferred among and between the various physical machine hosts, either as images or after instantiation of the VCE. Cloud orchestration module 1941 manages the transfer and storage of images, deploys new instantiations of VCEs and manages active instantiations of VCE deployments. Gateway 1940 is the collection of computer software, hardware, and firmware that allows public cloud 1905 to communicate through WAN 1902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1906 is similar to public cloud 1905, except that the computing resources are only available for use by a single enterprise. While private cloud 1906 is depicted as being in communication with WAN 1902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1905 and private cloud 1906 are both part of a larger hybrid cloud.

The letter designators, such as i, j, N, n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for generating a mapping of a first transform network to a second transform network, the computer program product comprising a computer readable storage medium having computer readable program code embodied therein that is executable to perform operations, the operations comprising:
providing a first transform network having N input nodes and successive columns of interlinked nodes at which input data is processed;
generating a mapping of the N input nodes to n input nodes of a second transform network implemented in processing tiles in a hardware unit, wherein n is less than N, wherein multiple of the N input nodes of the first transform network map to one of the n input nodes of the second transform network; and
providing the mapping to use to map the N input nodes of the first transform network to n input nodes of the second transform network, wherein the second transform network is implemented in hardware.

2. The computer program product of claim 1, wherein the operations further comprise:
reordering the n input nodes for the second transform network, wherein the mapping maps the N input nodes for the first transform network to the reordered n input nodes in the second transform network.

3. The computer program product of claim 1, wherein the first transform network comprises an N-point butterfly network, wherein the second transform network comprises an n-point butterfly network, and wherein the mapping reduces the N-point butterfly network to map multiple butterfly operations to a same processing tile.

4. The computer program product of claim 1, wherein n is a function of a number of processing units and a number of input elements per processing unit.

5. The computer program product of claim 1, wherein the generating the mapping further comprises:
performing a folding of the N input nodes for the first transform network by mapping a first half of the N input nodes to a second half of the N input nodes.

6. The computer program product of claim 5, wherein the folding of the N input nodes of the first transform network comprises a first folding of the first transform network to produce an interim transform network of N′ input nodes, wherein N′ is less than N, and wherein the operations further comprise:
performing a reordering of the N′ input nodes; and
performing a second folding of the interim transform network by mapping a first half of the re-ordered N′ input nodes of the interim transform network and a second half of the interim transform network to the n inputs.

7. The computer program product of claim 6, wherein a number of foldings and re-orderings performed is a function of N, a number of processing units, and a number of input elements presented to the processing units.

8. The computer program product of claim 1, wherein the first transform network comprises an N-point radix singleton transform and wherein the second transform network comprise an N/2^{F}-point singleton transform, wherein F is a number of foldings and re-orderings.

9. A system for generating a mapping of a first transform network to a second transform network, comprising:
a processor; and
a computer readable storage medium having computer readable program code embodied therein that when executed by the processor performs operations, the operations comprising:
providing a first transform network having N input nodes and successive columns of interlinked nodes at which input data is processed;
generating a mapping of the N input nodes to n input nodes of a second transform network implemented in processing tiles in a hardware unit, wherein n is less than N, wherein multiple of the N input nodes of the first transform network map to one of the n input nodes of the second transform network; and
providing the mapping to use to map the N input nodes of the first transform network to n input nodes of the second transform network, wherein the second transform network is implemented in hardware.

10. The system of claim 9, wherein the operations further comprise:
reordering the n input nodes for the second transform network, wherein the mapping maps the N input nodes for the first transform network to the reordered n input nodes in the second transform network.

11. The system of claim 9, wherein the first transform network comprises an N-point butterfly network, wherein the second transform network comprises an n-point butterfly network, and wherein the mapping reduces the N-point butterfly network to map multiple butterfly operations to a same processing tile.

12. The system of claim 9, wherein the generating the mapping further comprises:
performing a folding of the N input nodes for the first transform network by mapping a first half of the N input nodes to a second half of the N input nodes.

13. The system of claim 12, wherein the folding of the N input nodes of the first transform network comprises a first folding of the first transform network to produce an interim transform network of N′ input nodes, wherein N′ is less than N, and wherein the operations further comprise:
performing a reordering of the N′ input nodes; and
performing a second folding of the interim transform network by mapping a first half of the re-ordered N′ input nodes of the interim transform network and a second half of the interim transform network to the n inputs.

14. The system of claim 13, wherein a number of foldings and re-orderings performed is a function of N, a number of processing units, and a number of input elements presented to the processing units.

15. A computer implemented method for generating a mapping of a first transform network to a second transform network, comprising:
providing a first transform network having N input nodes and successive columns of interlinked nodes at which input data is processed;
generating a mapping of the N input nodes to n input nodes of a second transform network implemented in processing tiles in a hardware unit, wherein n is less than N, wherein multiple of the N input nodes of the first transform network map to one of the n input nodes of the second transform network; and
providing the mapping to use to map the N input nodes of the first transform network to n input nodes of the second transform network, wherein the second transform network is implemented in hardware.

16. The method of claim 15, further comprising:
reordering the n input nodes for the second transform network, wherein the mapping maps the N input nodes for the first transform network to the reordered n input nodes in the second transform network.

17. The method of claim 15, wherein the first transform network comprises an N-point butterfly network, wherein the second transform network comprises an n-point butterfly network, and wherein the mapping reduces the N-point butterfly network to map multiple butterfly operations to a same processing tile.

18. The method of claim 15, wherein the generating the mapping further comprises:
performing a folding of the N input nodes for the first transform network by mapping a first half of the N input nodes to a second half of the N input nodes.

19. The method of claim 18, wherein the folding of the N input nodes of the first transform network comprises a first folding of the first transform network to produce an interim transform network of N′ input nodes, wherein N′ is less than N, further comprising:
performing a reordering of the N′ input nodes; and
performing a second folding of the interim transform network by mapping a first half of the re-ordered N′ input nodes of the interim transform network and a second half of the interim transform network to the n inputs.

20. The method of claim 19, wherein a number of foldings and re-orderings performed is a function of N, a number of processing units, and a number of input elements presented to the processing units.
